(19) United States
(12) Patent Application Publication
(10) Pub. No.: US 2018/0293314 A1
(43) Pub. Date: Oct. 11, 2018

(54) SYSTEMS AND METHODS FOR GENERATING LOCATION PROFILES BASED ON VERIFIED USER INPUT

(71) Applicant: MasterCard International Incorporated, Purchase, NY (US)

(72) Inventor: Emily Munley, Liverpool, NY (US)

(21) Appl. No.: 15/485,013

(22) Filed: Apr. 11, 2017

(51) Int. Cl. G06F 17/30

(52) U.S. Cl. CPC G06F 17/30864; G06F 17/30241

(57) ABSTRACT

A location profile generator computing device comprising a processor, a memory, and a user interface is described herein. The location profile generator computing device is configured to receive input data from a first user including a location identifier and at least a first searchable tag, and to receive input data from a second user including the location identifier and at least a second searchable tag. The location profile generator computing device is also configured to verify the input data from the first and second users. The location profile generator computing device is further configured to store the verified input data in a database wherein the verified input data includes the location identifier and the at least first and second searchable tags, and to generate a profile corresponding to the location identifier wherein the profile is associated with the at least first and second searchable tags.

### BACKGROUND

The present application relates generally to verifying user input data and, more specifically, to network-based systems and methods for generating location profiles based on verified user input.

Consumers who dine out prefer to have their meal when and where they want, and frequently find themselves frustrated with the search process. Instant gratification is an expectation of consumers from the time of ordering their food, to pick-up, and to payment, particularly with respect to speed and convenience. In view of these consumer expectations, merchants (e.g., restaurants, bars, coffee shops, etc.) must now integrate instantaneous and flexible customer relationship strategies and technologies if they wish to successfully manage reservations, customer relationships, and loyalty. In addition, many consumers want to use their smartphones to take advantage of merchant-offered loyalty programs and promotions.

Accordingly, there is a need for a system that properly targets user preferences in tailored search results and provides profiles generated by other users. To that end, active consumer contribution (e.g., crowdsourcing) of searchable tags is important for tailored merchant profiling. A profile database built by users whose input is verified by location-tracking and/or transaction-tracking services is described herein. In a particular embodiment, the system allows users/consumers to find food in a fun, fast, and easy way by connecting smartphone users with targeted merchants for a seamless dining experience.

### BRIEF DESCRIPTION OF THE DISCLOSURE

In one aspect, a location profile generator computing device is provided. The location profile generator computing device comprises a processor in communication with a memory and a user interface. The processor is programmed to receive input data from a first user, the input data from the first user including a location identifier and at least a first searchable tag, and receive input data from a second user, the input data from the second user including the location identifier and including at least a second searchable tag. The processor is also programmed to verify the input data from the first and second users. The processor is further configured to store the verified input data in the memory, the verified input data including the location identifier and the at least first and second searchable tags, and generate a profile corresponding to the location identifier, the profile being associated with the at least first and second searchable tags.

In another aspect, a method for generating location profiles based on verified user input is provided. The method is performed using a location profile generator computing device that includes a processor in communication with a memory and a user interface. The method includes receiving input data from a first user, the input data from the first user including a location identifier and at least a first searchable tag, and receiving input data from a second user, the input data from the second user including the location identifier and including at least a second searchable tag. The method also includes verifying the input data from the first and second users. The method further includes storing the verified input data in the memory, the verified input data including the location identifier and the at least first and second searchable tags, and generating a profile corresponding to the location identifier, the profile being associated with the at least first and second searchable tags.

In yet another aspect, a non-transitory computer-readable storage medium having computer-executable instructions embodied thereon is provided. When executed by a location profile generator (LPG) computing device that includes at least one processor coupled to a memory and a user interface, the computer-executable instructions cause the LPG computing device to receive input data from a first user, the input data from the first user including a location identifier and at least a first searchable tag, and receive input data from a second user, the input data from the second user including the location identifier and including at least a second searchable tag. The computer-executable instructions also cause the LPG computing device to verify the input data from the first and second users. The computer-executable instructions further cause the LPG computing device to store the verified input data in the memory, the verified input data including the location identifier and the at least first and second searchable tags, and to generate a profile corresponding to the location identifier, the profile being associated with the at least first and second searchable tags.

### BRIEF DESCRIPTION OF THE DRAWINGS

FIGS. 1-7(A-H) show example embodiments of the methods and systems described herein.

FIG. 1 is a block diagram of location profile generating (LPG) system including an LPG computing device.

FIG. 2 illustrates an example configuration of a user computing device shown in FIG. 1.

FIG. 3 illustrates an example configuration of a server system shown in FIG. 1.

FIG. 4 is a data flow diagram illustrating the flow of data between various components of the LPG system shown in FIG. 1.

FIG. 5 is a flowchart of a method for using a location profile generator computing device to generate location profiles based on verified user input.

FIG. 6 is a diagram of components of an example computing device that may be used in the LPG system shown in FIG. 1.

FIG. 7A is a first example screenshot of a software application (“app”) on a user interface of the LPG computing device showing an account menu screen.

FIG. 7B is a second example screenshot of the app shown in FIG. 7A, showing a voice recognition ordering screen.

FIG. 7C is a third example screenshot of the app shown in FIG. 7A, showing a search prompt screen.

FIG. 7D is a fourth example screenshot of the app shown in FIG. 7A, showing a friend feed screen.

FIG. 7E is a fifth example screenshot of the app shown in FIG. 7A, showing a search result screen.

FIG. 7F is a sixth example screenshot of the app shown in FIG. 7A, showing a check-in screen.

FIG. 7G is a seventh example screenshot of the app shown in FIG. 7A, showing a payment screen.

FIG. 7H is an eighth example screenshot of the app shown in FIG. 7A, showing a coupon/promotion screen.

Like numbers in the Figures indicates the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The location profile generator (LPG) system described herein is configured to receive input data from a first and second user, and to verify the input data. If the input data is verified, the LPG system stores the verified input data in a database and generates location profiles based on location identifiers included in the input data. For example, the LPG system generates a profile corresponding to a location identifier such that the profile includes all searchable tags associated with the particular location identifier as received in the user input.

In some embodiments, the location profile generator (LPG) system described herein is also configured to provide a seamless dining experience with services offered through the user interface with an integrated platform that incorporates functionality of the LPG computing device. In some embodiments, the integrated platform includes food finding (e.g., when the generated location profiles correspond to food merchant profiles), social, and payment components, which together provide customized searching, targeted results, reservations and ordering, check-in and delivery, payment and reviewing, and transaction data tracking features.

In the example embodiment, the LPG system includes an LPG computing device including and/or in communication with a user interface. The LPG computing device is configured to receive input data from users (such as location identifiers and associated searchable tags), verify the input data, store the verified input data, and generate a profiles corresponding to the location identifiers and their associated searchable tags. In some embodiments, the LPG computing device further includes a location profile application (“app”) via which the LPG computing device is additionally configured to display targeted search results based on user-customized filters, receive orders and reservations, enable check-in using geo-location services, enable payment with an associated payment account, and associate information from a completed transaction with a user's app account profile. The LPG computing device may include a specifically configured computing device that is capable of functioning as described herein, including a dedicated computing device (or devices) associated solely with the LPG system. The LPG computing device includes a processor in communication with a memory.

The LPG system further includes a database in wired and/or wireless communication with the LPG computing device. The database is accessible to the LPG computing device and is configured to store and/or otherwise maintain a variety of information, as described further herein. For example, the database may store verified user input data such as location identifiers, searchable tags, and images, generated location profiles, input verification modules, profile generator modules, user profiles including payment account identifiers and other settings, search preferences, search filters (such as designated searchable tags), favorite location profiles (such as merchant profiles), activity feed postings, transaction data, and/or any other information.

The LPG computing device is configured to maintain the user interface for communication between the user and the LPG computing device. In the example embodiment, the LPG computing device is configured to execute instructions causing display of a software application (“app”) or browser associated website with the input and output functionality described herein. In such embodiments, the user may input information to the LPG computing device via the app or browser, as displayed on the user interface. The user interface may be integral to a user computing device (such as a smartphone, a tablet, a laptop computer, or a wearable computing device (e.g., a smart watch)) that is “paired with” or otherwise in communication with the LPG computing device, such that the LPG computing device causes display of the app or browser as a virtual user interface on a physical user interface of the user computing device. The user can download the app to a user device, and set-up an account and profile with the LPG computing device via the app, which may include associating one or more payment account identifiers with the user's account/profile. In some embodiments, the app is a cloud-based application, such that information associated with the app (e.g., user profiles and associated payment account identifiers, user input data including location identifiers and associated searchable tags, user search preferences and filters, transaction data, etc.) is stored remotely and/or in a cloud environment (e.g., not in one centralized database). Moreover, the app is configured to enable access from a plurality of user computing device(s) to the profile generation services of the LPG computing device, to make the profile contribution and searching experience more efficient and less burdensome for the user. In some embodiments, the app may have inter-app integration functionality, such that the intake tracking services of the app may be integrated with, for example, geo-locator (such as GPS) and/or payment services of another application.

In the example embodiment, the user accesses the app or browser via the user interface. The LPG computing device causes display of a prompt for the user to enter input data, including a location identifier, at least one searchable tag, and any other data associated with the identified location (e.g., images/photos). In some embodiments, the LPG computing device causes display of drop-down lists, text entry fields, buttons, other selection or entry fields, and/or combinations thereof for the user to select, set, edit, update, and/or define the input data associated with the location.

As used herein, a location profile may be, for example, a merchant such as a restaurant or retailer, a recreational destination (park, hotel, resort), an entertainment/event venue, etc. In general, the location profiles generated herein may include any locatable entity that provides a good, service, and/or experience and may generally benefit from the availability of reliable (i.e., source data from user input has been verified) crowdsourced profiles. In the example implementation, a user is generally considered to be a consumer of some good, service, experience, etc. In some embodiments, when a location identifier designates, for example, a restaurant or a clothing retailer, the user may be a customer. In some embodiments, when a location identifier designates, for example, a park or event venue, the user may be a visitor, attendee, or ticket holder. As described herein, a user is not generally intended to represent an owner of the location associated with the location identifier (e.g., a merchant, business owner/manager associated with the location, etc.). The users contributing input data related to a particular location are not intended to be identical to website/content developers for the merchant/vendor at the particular location. That is, the generated profiles are not stored at a server associated with a website of the merchant/location. In some embodiments, the generated profiles may include a link or other type of information that would direct a searching user to an external website apart from the generated profile associated with the location.

In the example implementation, any information stored on the LPG system does not include any personally identifiable information (PII), but rather includes analyzed, anonymized, and/or aggregated data that does not specifically identify a user/consumer. In other implementations, where the LPG system may store PII, any stored PII is encrypted and/or otherwise secured. Moreover, in any implementations in which PII may be collected, the user from which the PII may be collected is provided an opportunity to agree to or deny collection of such data.

The methods and systems described herein may be implemented using computer programming or engineering techniques including computer software, firmware, hardware, or any combination or subset therefor. At least one of the technical problems addressed by this system includes: (i) lack of reliable location-based profiles generated using verified user input; (ii) lack of relevant, user-assigned, searchable tags in location-based profiles; and (iii) tedious, complicated, and/or inconvenient profile searching.

The technical effect of the systems and methods described herein is achieved by performing at least one of the following steps: (i) receiving input data from a first user including a location identifier and at least a first searchable tag; (ii) receiving input data from a second user including the location identifier and at least a second searchable tag; (iii) verifying the input data from the first and second users; (iv) storing the verified input data in a memory including the location identifier and the at least first and second searchable tags; and (v) generating a profile corresponding to the location identifier, such that the profile is associated with the at least first and second searchable tags.

The resulting technical effect achieved by the systems and methods described herein is at least one of: (i) reliable crowdsourced profiles generated using verified user input; (ii) location profiles that are associated with relevant searchable tags; and (iii) improved, simplified, and targeted profile searching that outputs tailored results. These solutions are necessarily tied to a computing device, specifically the specialized LPG computing device described herein. The verification of user input requires (i) communication with a financial entity, and/or (ii) communication with a geo-locating entity.

In one embodiment, a computer program is provided, and the program is embodied on a computer-readable medium. In an example embodiment, the LPG system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the LPG system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing purchase patterns in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

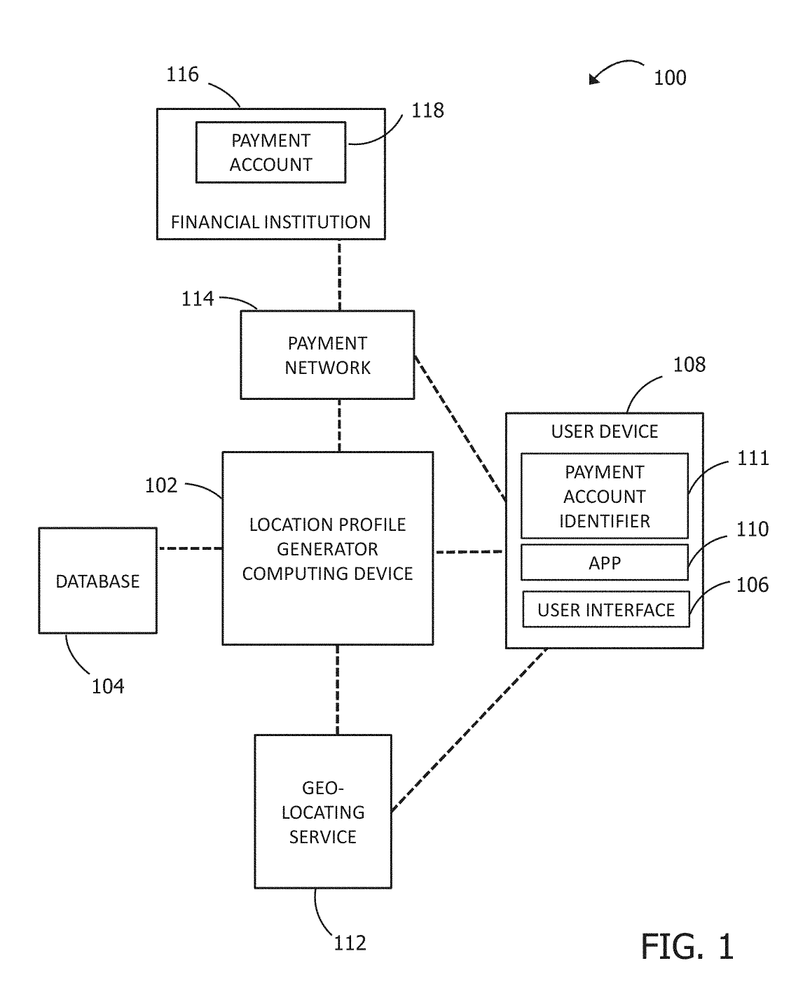

FIG. 1 is a block diagram of a location profile generator (LPG) system 100 including an LPG computing device 102. LPG computing device 102 includes at least one processor in communication with a memory. LPG computing device 102 is in communication with a database (memory) 104 containing information on a variety of matters, including verified user input data such as location identifiers, searchable tags, and images, generated location profiles, input verification modules, profile generator modules, user profiles and associated payment account information, payment account transaction data, user search preferences and settings, and/or any other information. In one embodiment, database 104 is stored on LPG computing device 102. In any alternative embodiment, database 104 is stored remotely from LPG computing device 102 and may be non-centralized.

In the example embodiment, LPG system 100 further includes a plurality of client subsystems, also referred to as client systems or user computing devices 108. In one embodiment, user computing devices 108 are computers including a web browser, such that LPG computing device 102 is accessible to user computing devices 108 using the Internet. User computing devices 108 are interconnected to the Internet through many interfaces including a network, such as a local area network (LAN) and/or a wide area network (WAN), dial-in connections, cable modems, wireless-connections, and special high-speed ISDN lines. User computing devices 108 may be any device capable of interconnecting to the Internet including a mobile computing device, such as a laptop or desktop computer, a web-based phone (e.g., a “smartphone”), a personal digital assistant (PDA), a tablet or phablet, a fitness wearable device, a “smart watch” or other wearable device, or other web-connectable equipment. Although one user computing device 108 is shown in FIG. 1 for clarity, it should be understood that LPG system 100 may include any number of user computing devices 108.

In one embodiment, LPG computing device 102 is configured to communicate with a user computing device 108 associated with a user (not shown). User computing device 108 is configured to display various functionality of a computer software application (or app) 110 via user interface 106 (described further herein). The app 110 may be stored in a cloud-based interface (not shown), which may include cloud storage capability as well as any cloud-based API that facilitates communicates between a user computing devices 108 and LPG computing device 102 and/or between geo-locating service (computing devices) 112. The user accesses app 110 (which may be a location profile app) to access the profile building services of LPG computing device 102, as well as to enable data verification using, for example, payment network 114 and/or geo-locating services 112. For example, the user downloads app 110 to user device 108 and sets-up an account/profile with LPG computing device 102 via app 110. Setting up a user account (or registering) with LPG computing device 102 via app 110 may include associating one or more payment account identifiers 111 (such as a primary account number, or PAN) with the user account/profile via the app 110 and, in some embodiments, associating one or more payment account identifiers 111 with a particular user device 108. In some embodiments, the PAN may be representative of one or more user (or cardholder) identifiers and/or account identifiers 111, which identify a payment account 118 and one or more payment methods (e.g., physical card, chip card, tokenized device) associated with payment account 118. The payment account identifiers 111 may include device identifiers associated with each payment method, such as a phone number, email address, card number, token, or other similar contact information associated with a device 108 or a user of the device. Payment account identifier(s) 111 may be used for verification purposes (e.g., by leveraging various transaction data associated with a payment account 118 tied to payment account identifier 111) by LPG computing device 102, as described further herein. In some embodiments, geo-locating service 112 is integral to LPG computing device 102. In some embodiments, app 110 may have inter-app integration functionality, such that the location profile generating services of the app 110 may be integrated with, for example, geo-locating services of another application.

LPG system 100 further includes a geo-locating service (computing device) 112, which may include any computing device capable of communicating with LPG computing device 102 to verify a location. In the example embodiment, LPG computing device 102 may access geo-locating service 112 through a cloud-based interface or API. LPG computing device 102 is configured to communicate with geo-locating service 112 to access geo-locating functionality to identify the location of a user device 108 (i.e., the user device 108 from which input data has been received). Location discovery may be obtained from geo-locating service 112 for various time points and/or durations in order to support verification by the LPG computing device 102. For instance, when LPG computing device 102 receives input data (including a location identifier) from a user (via user device 108), LPG computing device 102 may request access from geo-locating service 112 for location information related to the user device 108 covering, for example, the previous 24 hours. In another example, LPG computing device 102 may request location information covering the previous 7 days. Depending on the embodiment, verification criteria for verifying a location identifier (included in input data from a user) in relation to the location of user device 108 may vary. Although only one geo-locating service 112 is shown in FIG. 1 for clarity, it should be understood that LPG computing device 102 may be in communication with any number of geo-locating services 112.

In the illustrated embodiment, LPG computing device 102 is in communication with a payment network 114. Payment network 114 is configured to process financial transactions thereover. Payment network 114 is in communication with a plurality of financial institutions 116 (e.g., banks), although only one financial institution 116 is shown for clarity. Financial institution 116 maintains one or more financial/payment accounts 118 associated with a user of user computing device 108, such as a credit card account, debit account, or prepaid account. Payment account identifier 111 (such as a primary account number, or PAN) is tied to a payment account 118. LPG computing device 102 may verify a location identifier (included in input data from a user) via payment network 114 using transaction data associated with the user. For example, app 110 may enable a user to perform various activities related to a transaction, and the associated transaction data may be used for verification purposes by the LPG computing device 102. The transaction data used for verification purposes by the LPG computing device may be data that is representative of a user's location for comparison to the location identifier and/or data that confirms a user's interaction with a particular merchant associated with the location identifier. Transaction data associated with the user may include data associated with a check-in of the user into app 110 via the user interface 106 for confirming that the user has arrived at the location, an order placement associated with the user through app 110 via user interface 106 that confirms that the user has placed an order for an item with a merchant at the location, a payment associated with the user through app 110 via user interface 106 that confirms that the user has paid a merchant at the location, and/or any other transaction data associated with a user payment account that can be tied to a location and obtained by accessing payment network 114. In some embodiments, LPG computing device 102 is in direct communication with financial institution 116 and verifies input data directly therefrom, without the intervention of payment network 114.

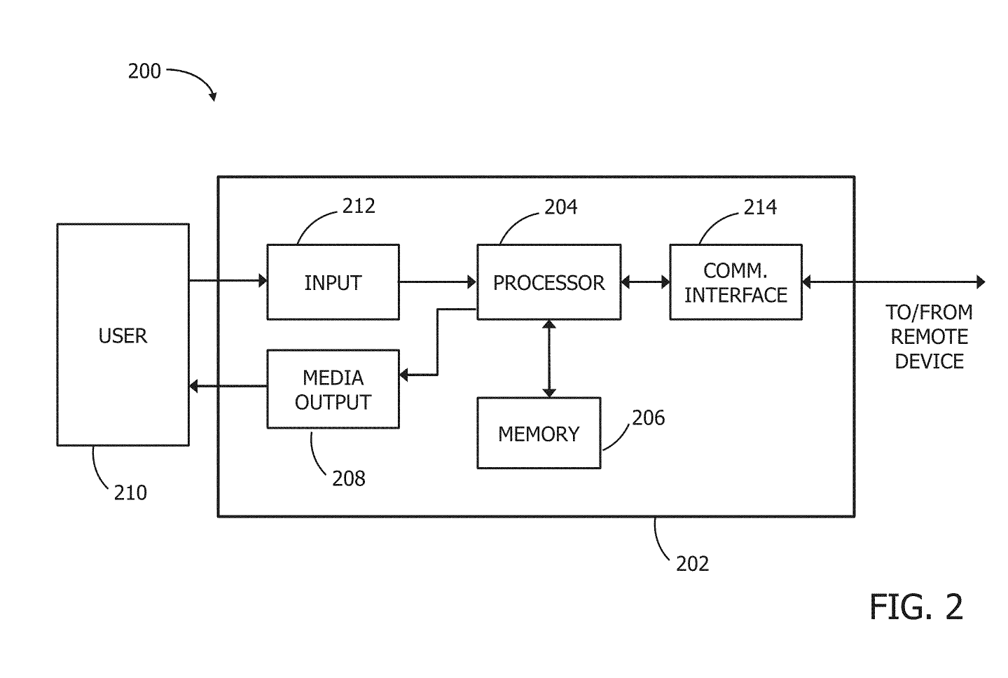

FIG. 2 illustrates an example configuration of a user computing device 202. User computing device 202 may include, but is not limited to, client systems (“user computing devices”) 108 and geo-locating service 112 (shown in FIG. 1). User computing device 202 includes a processor 204 for executing instructions. In some embodiments, executable instructions are stored in a memory area 206. Processor 204 may include one or more processing units (e.g., in a multi-core configuration). Memory area 206 is any device allowing information such as executable instructions and/or other data to be stored and retrieved. Memory area 206 may include one or more computer-readable media.

User computing device 202 also includes at least one media output component 208 for presenting information to a user 210. Media output component 208 is any component capable of conveying information to user 210. In some embodiments, media output component 208 includes an output adapter such as a video adapter and/or an audio adapter. An output adapter is operatively coupled to processor 204 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, user computing device 202 includes an input device 212 for receiving input from user 210. Input device 212 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen (e.g., user interface 106, shown in FIG. 1) may function as both an output device of media output component 208 and input device 212.

User computing device 202 may also include a communication interface 214, which is communicatively coupleable to a remote device such as LPG computing device 102 or a web server operated by a third party (e.g., geo-locating service 112 and payment network 114, both shown in FIG. 1). Communication interface 214 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 206 are, for example, computer-readable instructions for providing a user interface to user 210 via media output component 208 and, optionally, receiving and processing input from input device 212. A user interface may include, among other possibilities, a web browser and client application. Web browsers enable users 210 to display and interact with media and other information typically embedded on a web page or a website from a web server, for example, associated with a profile generating and/or search service. A client application (such as app 110, shown in FIG. 1) allows users 210 to interact with a server application associated with, for example, the LPG system 100 (shown in FIG. 1).

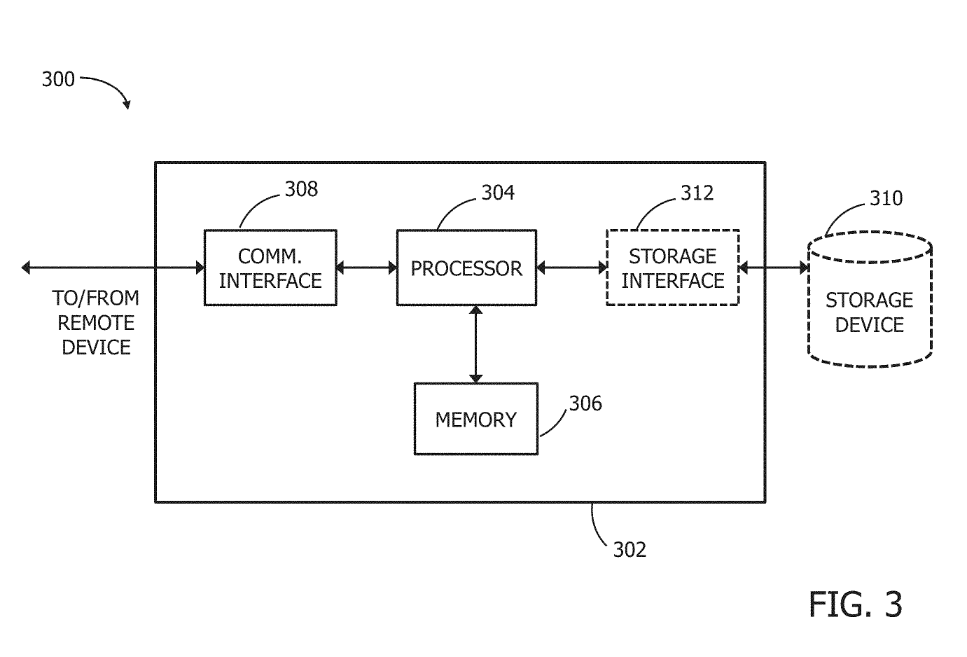

FIG. 3 illustrates an example configuration of a server computing device 302. Server computing device 302 may include, but is not limited to, LPG computing device 102, geo-locating service (computing device) 112, payment network 114 (all shown in FIG. 1). Server computing device 302 includes a processor 304 for executing instructions. Instructions may be stored in a memory area 306, for example. Processor 304 may include one or more processing units (e.g., in a multi-core configuration).

Processor 304 is operatively coupled to a communication interface 308 such that server computing device 302 is capable of communicating with a remote device such as user computing device 202 or another server computing device 302. For example, communication interface 308 may receive input data and/or requests from user computing devices 108 via the Internet, as illustrated in FIG. 1.

Processor 304 may also be operatively coupled to a storage device 310. Storage device 310 is any computer-operated hardware suitable for storing and/or retrieving data. In some embodiments, storage device 310 is integrated in server computing device 302. For example, server computing device 302 may include one or more hard disk drives as storage device 310. In other embodiments, storage device 310 is external to server computing device 302 and may be accessed by a plurality of server computing devices 302. For example, storage device 310 may include multiple storage units such as hard disks or solid state disks in a redundant array of inexpensive disks (RAID) configuration. Storage device 310 may include a storage area network (SAN) and/or a network attached storage (NAS) system.

In some embodiments, processor 304 is operatively coupled to storage device 310 via a storage interface 312. Storage interface 312 is any component capable of providing processor 304 with access to storage device 310. Storage interface 312 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 310.

Memory areas 306 and 206 (shown in FIG. 2) may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

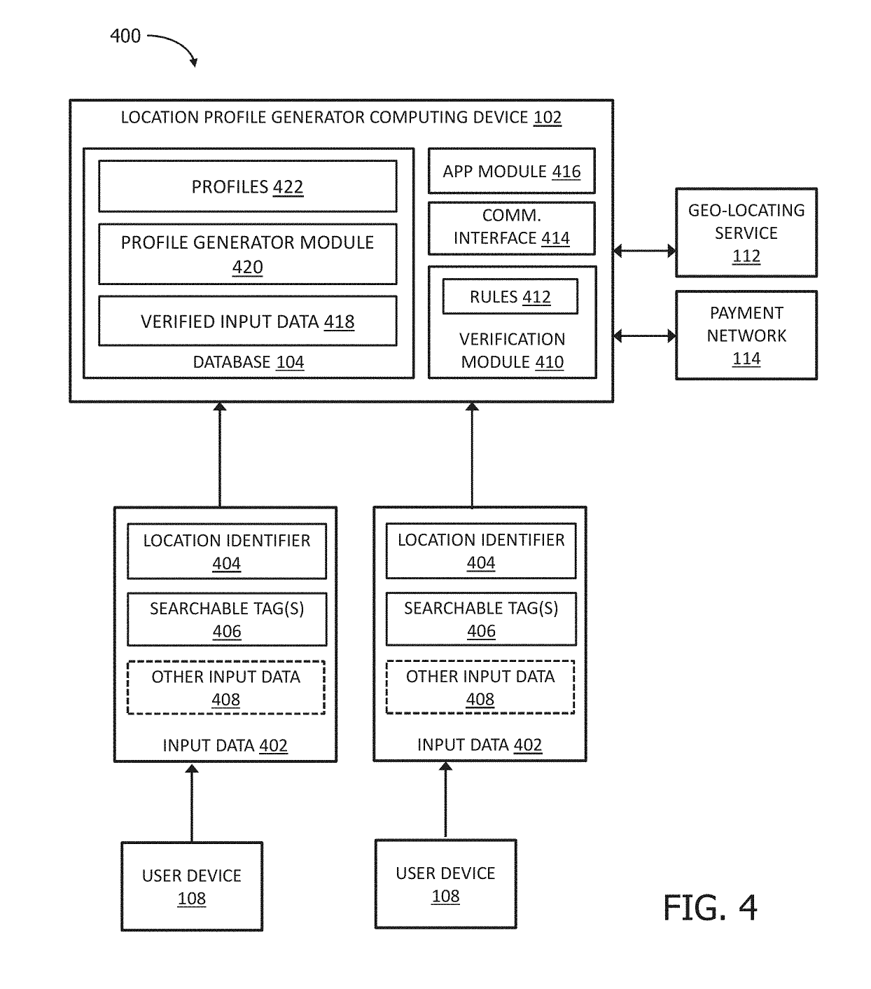

FIG. 4 is a data flow diagram 400 illustration the flow of various data between components of LPG system 100 (shown in FIG. 1). In the illustrated embodiment, as described above with respect to FIG. 1, LPG computing device 102 is in communication with database 104, user computing device(s) 108, geo-locating service (computing device) 112, and payment network 114 (e.g., a payment processor). Although database 104 is illustrated as a separate and external component, it should be understood that, in an alternative embodiment, database 104 is a centralized database integral to LPG computing device 102.

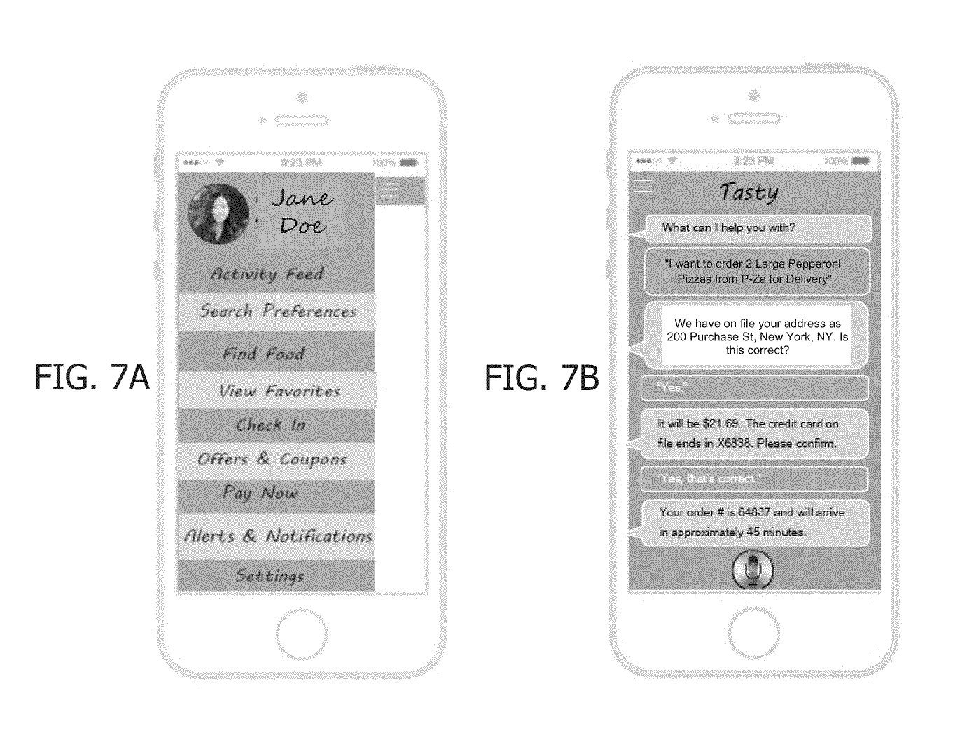

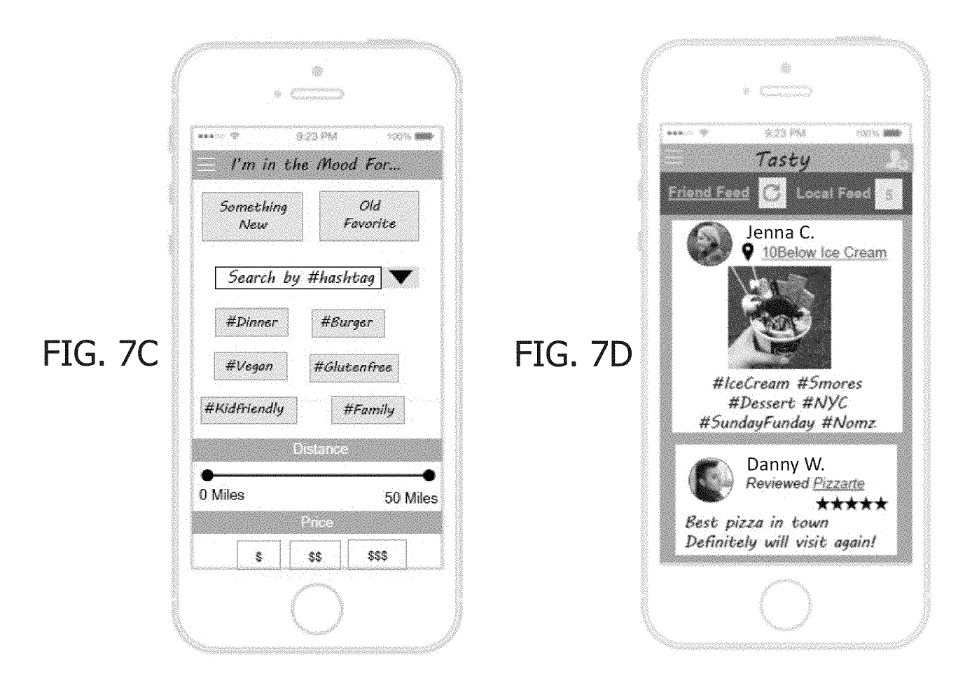

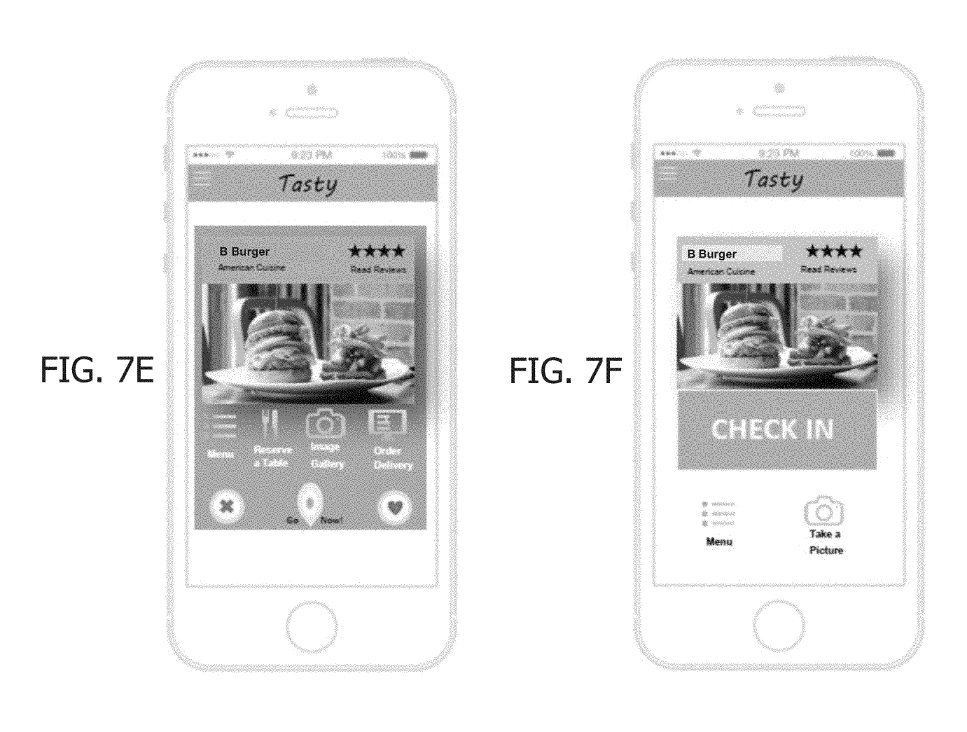

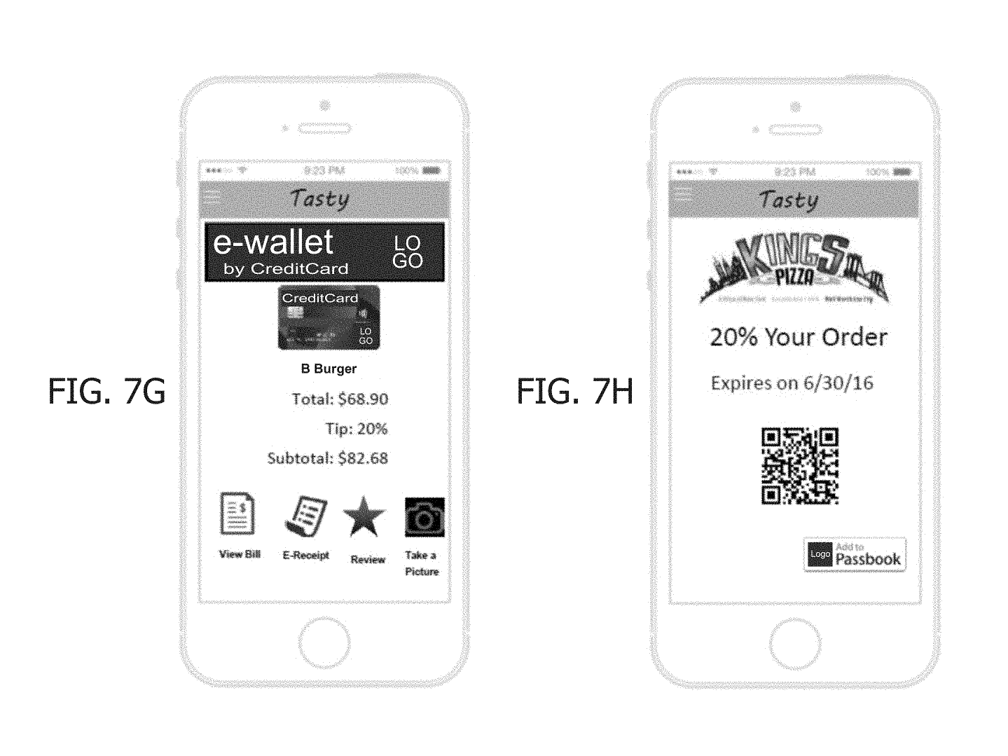

In the illustrated embodiment, LPG computing device 102 is configured to receive input data 402 from any number of user devices 108, verify input data 402, store verified input data 418 in database 104, and generate profiles 422 using verified input data 418. More particularly, a user of user computing device 108 accesses a user interface 106, such as, for example, a touch screen configured to display a graphical user interface (GUI) at a user computing device 108 that is “paired with” or otherwise in communication with LPG computing device 102. In the example embodiment, LPG computing device 102 includes an app module 416 configured to maintain and make available a software application (such as app 110, shown in FIG. 1) at user interface 106. App module 416 may be further configured to maintain a browser-accessible website. User interface 106 at user computing device 108 refers to a GUI displayed on a physical user interface (not shown) of user computing device 108, for example, within the app maintained by app module 416. In other words, a user can access the functionality of LPG computing device 102 remotely with user computing device 108 through displayed user interface 106 (e.g., within an app). The user accesses the app as described above to, among other things, input data intended for profile generation, maintain a user account (see FIG. 7A), place an order using voice recognition functionality (see FIG. 7B), perform a targeted search (see FIG. 7C), view a friend feed or a local feed as part of an integrated social platform (FIG. 7D), view targeted search results (see FIG. 7E), place an order for take-out or delivery (not shown), make a reservation and check-in (see FIG. 7F), make a payment (see FIG. 7G), and view coupons, promotions, and/or rewards (see FIG. 7H). In some embodiments, the app may have inter-app integration functionality, such that the profile generating and data verifying services of LPG computing device 102 may be integrated with, for example, geo-locating services and/or payment services of another application.

Input data 402 sent from user device(s) 108 and received at LPG computing device 102 includes at least a location identifier 404 and one or more searchable tags 406. Input data 402 may additionally include other input data 408 such as images, user ratings, and/or user comments/reviews, for example. Once received at LPG computing device 102, input data 402 is subject to verification prior to being incorporating into any generated location profile 422. For example, when a location identifier 404 pinpoints a merchant location such as a restaurant, the location profile 422 will be a profile corresponding to the restaurant. In order for information found in the restaurant profile to be reliable/relevant, input data 402 associated with the location identifier 404 that was submitted by a user must be verified to confirm that the user was actually either present at the merchant location (in this case, the restaurant), and/or interacted with the merchant in some demonstrable way (such as by purchasing a meal). The verification process (as further described below) ensures that profiles are generated from reliable user input data. In some embodiments, generated location profiles 422 may be subject to a tailored search that includes searchable tags 406 (and optionally other search preferences and/or filters) relevant to a searching user and can accordingly provide conveniently targeted profile results and related profile functionality via apps 416 and 110 and user interface 106.

In the illustrated embodiment, LPG computing device 102 includes app module 416, a communication interface 414, and a verification module 410. Communication interface 414 enables communication between LPG computing device 102 and at least one of user computing device 108, geo-locating service 112, and payment network 114. Verification module 410 is configured to verify input data received from a user (i.e., via user computing device 108), as described further herein. App module 416 and verification module 410 may be embodied as computer-executable instructions configured for execution by LPG computing device 102, for example, using a processor (e.g., processor 304, shown in FIG. 3). Alternatively, app module 416 and/or verification module 410 may be executed on separate processing components. It should be understood that LPG computing device 102 may include fewer, more, and/or alternative modules.

Additionally, LPG computing device 102 includes and/or is in communication with database 104, such that LPG computing device 102 may store information on database 104 and/or access information previously stored thereon. In the illustrated embodiment, database 104 stores at least verified input data 418, profile generator module 420, generated profiles 422, and/or other information, as described further herein. Database 104 may store additional and/or alternative information, such as verified input data and generated profiles, and/or any other information.

Upon receipt of input data 402 from user device 108, LPG computing device 102 verifies input data 402 using verification module 410 and rules 412. Verification includes confirming that the user (e.g., via user device 108 location and/or user-related transactions) can be tied to a location associated with location identifier 404. In some embodiments, verification module 410 may access geo-locating service 112 via communication interface 414 in order to verify a location of user device 108 from which input data 402 was received. Location data for user device 108 may be accessed through geo-locating service 112 for various time points and/or durations in order to support verification by verification module 410. In some embodiments, when LPG computing device 102 receives input data (including a location identifier 404) from user device 108, verification module 410 may request access from geo-locating service 112 for location information related to user device 108 covering, for example, the previous 24 hours, the previous 7 days, etc. Depending on the embodiment, rules 412 for verifying a location identifier 404 in relation to the location of user device 108 may vary. For instance, rules 412 may dictate that input data 402 must be verifiable from location data within the previous 24 hours. In other words, if user device 108 location data from the previous 24 hours obtained from geo-locating service 112 does not match the location identifier, then input data 402 is not verified and is not stored in database 104. In another example, rules 412 may allow input data 402 to be verified if location data for user device 108 matches location identifier 404 at any time within the previous 7 days. Alternatively or additionally, rules 412 may include a duration requirement. For example, a minimum duration at a particular location (i.e., the location associated with location identifier 404) may be required for verification of input data 402 as confirmation that a user did not merely just walk/ride past the location.

In some embodiments, verification module 410 may access payment network 114 via communication interface 414 in order to verify input data 402. Rules 412 may dictate that certain transaction-related activities are required for verification. For example, a user wishing to assign a searchable tag 406 to a particular location identifier 404 must have completed some confirmable transaction and/or payment in order to be stored in database 104 as verified input data 402 and subsequently be used to generate (or be added to) a location profile 422. In some embodiments, when LPG computing device 102 receives input data (including a location identifier 404) from user device 108, verification module 410 may request access from payment network 114 for transaction data related to user device 108 and/or payment account identifier 111. Depending on the embodiment, rules 412 for verifying a location identifier 404 with regard user transaction data may vary. For instance, rules 412 may dictate that input data 402 must be verifiable from transaction data that includes data associated with a check-in of the user into app 110 via user interface 106 for confirming that the user has arrived at the location associated with location identifier 404. Additionally or alternatively, transaction data that meets verification criteria (i.e., rules 412) includes an order placement associated with the user made through app 110 via user interface 106 (shown in FIG. 1) that confirms that the user has placed an order for an item with a merchant at the location, and/or a payment associated with the user made through app 110 via user interface 106 that confirms that the user has paid a merchant at the location. In some embodiments, the time range over which transaction data relating to a particular location identifier 404 is valid may vary. For example, transaction data matching a location identifier 404 included in input data 402 may be considered valid if it occurred within the previous 24 hours, or the previous 7 days, etc., depending on the embodiment. Rules 412 may designate how aged transaction data can be in order to be verifiable for the sake of generating and/or contributing to location profiles 422 created by profile generator module 420. If there is no transaction data matching location identifier 404 to confirm the user was present at the location associated with location identifier 404, and/or if there is no confirmation that the user interacted with a merchant associated with location identifier 404, then input data 402 is not verified and is not stored in database 104. In some embodiments, rules 412 may dictate either location-based verified input data 402 (by accessing geo-locating service 112), transaction-based verified input data 402 (by accessing payment network 114), or both.

In the illustrated embodiment, input data 402 that has been verified is stored in database 104 as verified input data 418. According to each unique location identifier present in verified input data 418, profile generator module 420 is configured to generate a unique location profile 422. Each profile 422 includes searchable tags 406 and other input data 408 that were associated with location identifier 404 as part of input data 402 received at LPG computing device 102. In some embodiments, input data 402 received at LPG computing device 102 may include a particular location identifier 404 that already has a corresponding profile 422 in database 104. Profile generator module 420 is configured to append existing profile 422 with verified input data 418 associated with that particular location identifier 404, thereby increasing the amount of information (e.g., the number of searchable tags, ratings, reviews, images) included in the existing profile 422. In some embodiments, existing profile 422 may already include a certain searchable tag 406. Profile generator module 420 is configured to label (or otherwise indicate) the number of times a certain searchable tag has been associated with the particular location identifier 404 of existing profile 422. In this way, certain searchable tags can serve as weighted indicators showing a tag's frequency of association with the particular location. For example, if location identifier 404 pinpoints a restaurant, searchable tags 406 such as “kidfriendly” and “romanticevening” may be labeled according to their frequency of association with the restaurant. Continuing with this example, the labeled tags “kidfriendlyl⁵⁵” and “romanticevening¹⁸” may indicate that users have more often categorized this particular restaurant as kid-friendly than as suitable for a romantic evening.

FIG. 5 is a flowchart of a method 500 for generating location profiles based on verified user input. Method 500 may be performed using LPG computing device 102 (shown in FIG. 1).

Method 500 includes receiving 502 input data from a first user (e.g., input data 402 received from a user device 108, shown in FIG. 4), the input data from the first user including a location identifier and at least a first searchable tag (e.g., location identifier 404 and searchable tag(s) 406, both shown in FIG. 4). Method 500 also includes receiving 504 input data from a second user (e.g., input data 402 received from a user device 108, shown in FIG. 4), the input data from the second user including the location identifier and at least a first searchable tag (e.g., location identifier 404 and searchable tag(s) 406, both shown in FIG. 4). Method 500 further includes verifying 506 the input data from the first and second users (e.g., using verification module 410 including rules 412, for instance, by accessing payment network 114 and/or geo-locating service 112, shown in FIG. 4).

Method 500 also includes storing 508 the verified input data in a memory (e.g., verified input data 418 stored in database 104, as shown in FIG. 4), the verified input data including the location identifier and the at least first and second searchable tags (e.g., location identifier 404 and searchable tag(s) 406, shown in FIG. 4). Method 500 still further includes generating 510 a profile corresponding to the location identifier (e.g., profile 422 generated by, for example, profile generator module 420 using verified input data 418, shown in FIG. 4), the profile being associated with the at least first and second searchable tags. In the example embodiment, the profile corresponding to the location identifier is a merchant profile.

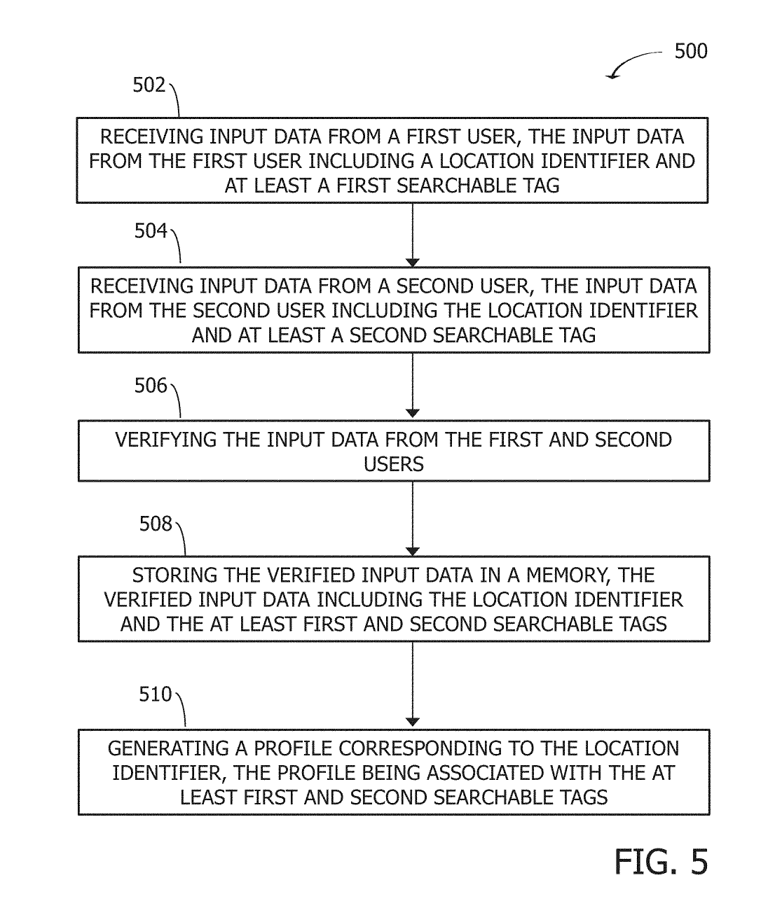

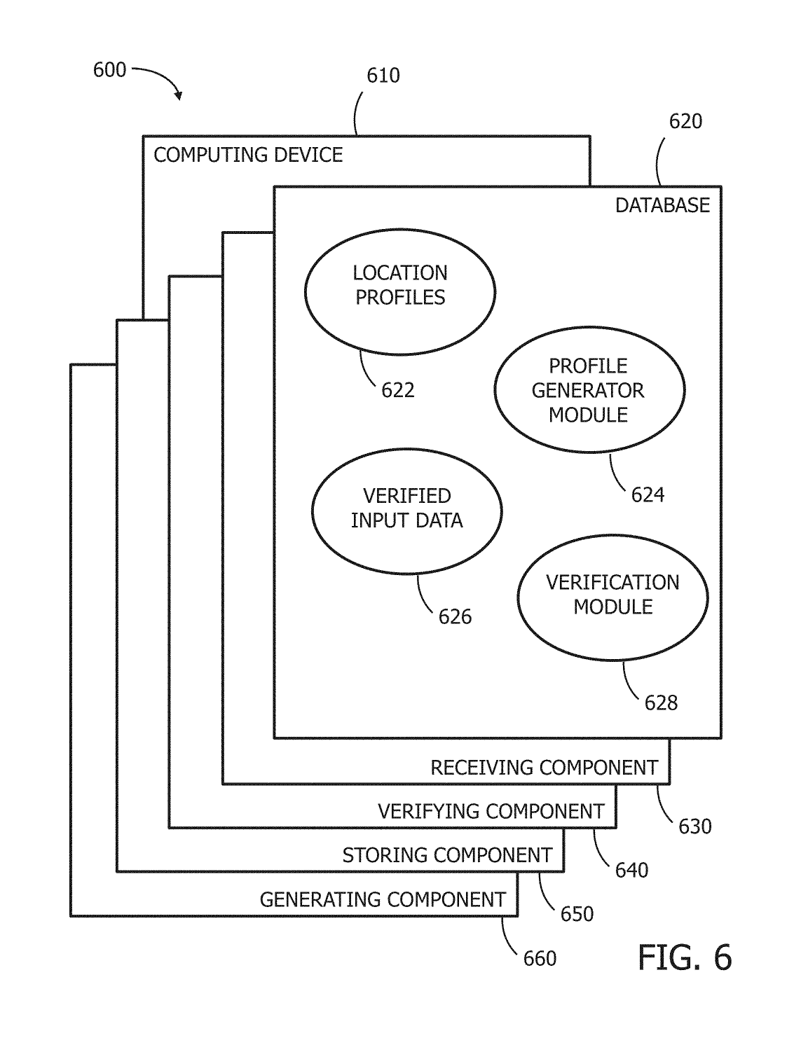

FIG. 6 is a diagram 600 of components of an example computing device 610 that may be used in the LPG system 100 shown in FIG. 1. In some embodiments, computing device 610 is similar to LPG computing device 102 (shown in FIG. 1). Computing device 610 includes a database 620 configured to store various information. Database 620 may be similar to database 104 (shown in FIG. 1). In the illustrated embodiment, database 620 stores location profiles 622 (which may include and/or be similar to profiles 422, shown in FIG. 4), profile generator module 624 (which may include and/or be similar to profile generator module 420, shown in FIG. 4), verified input data 626 (which may include and/or be similar to verified input data 418, shown in FIG. 4), and verification module 628 (which may include and/or be similar to verification module 410, shown in FIG. 4). Database 620 may be coupled with several separate components within computing device 610, which perform specific tasks.

In the example embodiment, computing device 610 includes a receiving component 630. Receiving component 630 is configured to receive input data from a first user, wherein the input data includes a location identifier and at least a first searchable tag. Receiving component 630 is further configured to receive input data from a second user, wherein the input data includes the location identifier and at least a second searchable tag. Computing device 610 also includes a verifying component 640, which is configured to verify the input data received from the first and second users.

Computing device 610 further includes a storing component 650. Storing component 650 is configured to store the verified input data 626, wherein the verified input data 626 includes the location identifier and the at least first and second searchable tags. Computing device 610 also includes a generating component 660 configured to generate a location profile 622 corresponding to the location identifier, wherein the profile 622 is associated with the at least first and second searchable tags. Computing device 610 may include fewer, more, and/or additional components, including transmitting, displaying, communication, and/or processing components.

With reference now to FIGS. 7A-7H, an example embodiment of LPG computing device functionality provided via a user device app is illustrated using a variety of screenshots. The functionality described with respect to FIGS. 7A-7H is based, at least in part, by the profiles generated using the LPG computing device with verified user input data. In the following example embodiment, location profiles (e.g., merchant profiles, as in the example embodiment described below for use with an integrated ‘food finder’ platform) stored in the LPG system database are accessed for targeted searching. Further, user input data received (e.g., via the illustrated app) and verified by LPG computing device during and/or after a search-related transaction is used to append existing profiles or generate additional profiles in the LPG system.

Regarding FIG. 7A, the user accesses the app or browser via the user interface. The LPG computing device causes display of an account menu associated with the user. The account menu allows the user to set search preferences, ‘find food’, place an order or make a reservation, check-in, make a payment, view coupons and promotions, and access activity feeds. Setting search preferences can include setting baseline filters to be included in (or at least available for) each customized search. The user can define one or more such search preferences according to, for example, cuisine type, meal type, dietary preferences or restrictions, family-friendly or kid-free accommodations, location, price range, and review rating. In the example embodiment, the search preferences set by the user include hashtag filters. Other search preferences can also be set, such as enabling voice recognition for searching and ordering (as shown in FIG. 7B). In embodiments where a voice recognition service is enabled, a user can verbalize their food search preferences and filters, receive targeted results as audible recommendations, and receive other audible prompts to aid in ordering, making reservations, checking-in, making payments, and posting ratings and reviews.

The ‘find food’ menu option allows a user to perform a customized merchant search. Merchants may include, for example, restaurants, cafes, bars, coffee shops, food trucks, catered feeding locations, meal delivery services, etc. With reference now to FIG. 7C, the LPG computing device causes display of a prompt for the user to begin their search by selecting an ‘old favorite’ or ‘something new’. In response to a user selecting an ‘old favorite’, the LPG computing device displays targeted merchant results based on previously selected favorites associated with the user's profile as well as transaction history associated with the user's payment account. A user may add favorite merchants to their user profile at various times, for example, when inputting search preferences or other user profile settings, when viewing targeted search results, when making a payment, when reviewing a merchant, or when posting to an activity feed.

In the example embodiment and in response to a user selecting ‘something new’, the LPG computing device causes display of a prompt for the user to select from and/or input various search filters, according to their preference for that particular search. In some embodiments, the LPG computing device causes display of drop-down lists, text entry fields, buttons, other selection or entry fields, and/or combinations thereof for the user to select, set, edit, update and/or define their customized search filters. For any particular search, a user can choose to include or exclude saved baseline filters from their profile, as well as to additionally or alternatively input other search filters. Search filters can include, for example, a specific dish, a type of food, dietary preferences, family-related accommodations, location, price range, and review rating, and can include hashtag filters as search queries.

The ‘find food’ option also enables browsing and searching based on a friend's (or friends') activity feed (as shown in FIG. 7D) or on a local activity feed. As part of the IFF system's social platform component, a user's LPG computing device account profile can have one or more associated friends and access to their respective activity feeds (including, e.g., ratings and reviews). A user can include the activity feed of a particular friend (or friends) as an additional or alternative search filter. In this way, search filters and merchants that are also found in the friend's activity feed are displayed in a search result set of targeted merchants. In some embodiments, a user can browse and search based on a local activity feed. That is, a user's customized hashtag filters and other customized search filters can be compared and matched to all user (friend or not) activity feeds with postings about merchants within a certain geographic area. In these embodiments, the LPG computing device can employ a geo-locating service to determine the location of the user device. For example, a user may wish to limit their targeted merchants to their current city or street, within a 5-mile radius of their current location, Manhattan, Michigan Avenue, or Bourbon Street. Targeted merchant results from a local activity feed may also be limited to a certain time period (e.g., limited to postings made within the last week, from last weekend, or since yesterday). Depending on the embodiment, results displayed in a local activity feed may or may not include the names/usernames of the local users whose ratings and/or reviews are displayed. Name/username display may be determined based on individual user preferences as saved within a user's profile settings, or alternatively may be determined automatically by the LPG computing device based on various settings.

With reference now to FIG. 7E, each targeted merchant result from a customized search is displayed as a page, allowing the user to easily swipe through and view the results. The page display result can include the merchant name, as well as other merchant-related information such as, cuisine type, average review rating, an image, location, hours, etc. Various selectable options may also be displayed on the merchant result page, such as an option to view a menu, view images, read reviews, make a reservation or place an order. In some embodiments, targeted merchant results may be displayed in a list format allowing the user to scroll through results of the customized search and make various selections. Returning to the example embodiment, a user can swipe to the left to view another targeted merchant, while a swipe to the right can select the displayed merchant to show the user additional details and options related to that particular merchant. For example, a swipe to the right may bring up a menu, an image gallery, recent reviews, reservation options, ordering and delivery options, etc. Depending on the embodiment, selection options for each targeted merchant may be displayed on the initial result page and/or on the more detailed, right-swiped page, so that a user can easily make a desired selection.

The LPG computing device allows a user to make a dine-in reservation, place an order for pick-up, or place an order for delivery via the app and user interface of their user device. The user can simply by choose the corresponding option (when available) as displayed for a selected merchant. This convenient feature saves the user of time spent waiting in line (e.g., on the phone or at the restaurant location) to talk to the host.

In the example embodiment, after the user selects a merchant and makes a reservation (or places an order), the LPG computing device is configured to pinpoint and/or track the location of the user device using a geo-locating service. In embodiments when the user has made a reservation or placed a pick-up order, the LPG computing device tracks the location of the user's device and causes display of a prompt to check-in (as shown in FIG. 7F) upon the user's arrival at the merchant location. Here again the user is saved time spent waiting in line to check-in with the host. In embodiments when the user has placed a delivery order, the LPG computing device pinpoints the location of the user's device and causes display of a prompt to confirm a delivery address for the order. The check-in feature can automatically track visits and allow merchants to send coupons/promotions to verified customers within the app (as described in further detail below). The check-in feature can also provide check-in frequency information to merchants, thus allowing each merchant to recognize the value of LPG computing device services with respect to their own business.

With reference now to FIG. 7G, a user can elect to pay via their user device within the app. For pick-up/delivery orders made through the app, payment may be made at the time of ordering or at the time of pick-up/delivery, depending on the embodiment. For example, a user may wish to wait to pay until the time of pick-up/delivery to make sure the order is correct and/or to add a tip. For dine-in reservations made through the app, there is no need to wait for the bill to arrive. A user can select the ‘pay now’ option on the app's account menu when they are ready to pay. Further, payment is quick and convenient when a user has a payment account identifier associated with their LPG computing device account profile, for example, with an integrated payment solution such as MasterPass. In some embodiments, a user can input a different payment account identifier (e.g., debit or credit card) at time of payment. For example, a user can find food, make reservations, and check-in through the app (i.e., in association with their own user profile) and still allow others to pay through the app. For instance, the user can make arrangements for their own birthday dinner, while a friend may wish to treat by paying the bill. In another instance, the user can make arrangements for a group, and each member of the group can pay for their respective meal via the app.

The LPG computing device also allows a user to rate and review merchants. Merchant rating and reviewing may be done at any time (as well as more than once) during the dining experience, as desired by the user. In some embodiments, once a transaction has been completed with a particular merchant by making a payment, the LPG computing device causes display of a prompt for the user to rate the merchant and/or write a review of the merchant. The user can post ratings and reviews to their own activity feed (as shown above in FIG. 7D), for viewing by their friends and/or on local activity feed according to user preference or as determined by the LPG computing device. Activity feed postings and rate/review features can include: assigning hashtags, taking and posting one or more pictures, sending a rating/review to friends, sending a recommendation to friends, embedding links to merchant-related sites/blogs/reviews/advertisements/etc.

With reference now to FIG. 7H, the LPG computing device is configured to integrate rewards program and/or loyalty program features. In some embodiments, a user can sign up for a program with a chosen merchant, and subsequent activity/transactions with the merchant can be tracked and credited to the user's reward/loyalty program via the app. A user may also be able to redeem rewards, coupons, and promotions via the app. In some embodiments, merchants can send coupons/promotions to users via the app, based on various user profile activity (e.g., identified favorites, confirmed check-in locations, completed transactions, etc.). Merchants can offer promotional SMS and/or email to users as optional features.

In summary, the location profile generating methods and systems described herein provide a reliable source of location-based profiles (e.g., merchant profiles), built by users and accessible to users for relevant searching and convenient goods/services consumption. In particular, by leveraging merchant profiles that are generated using verified user input, the LPG computing device and system can further provide integrated food finding, social, and payment platforms, for a seamless dining experience from start to finish through tailored recommendations and services based on verified user input, saved preferences, tracked information, and transaction data.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 204, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

In addition, although various elements of the LPG computing device are described herein as including general processing and memory devices, it should be understood that the LPG computing device is a specialized computer configured to perform the steps described herein for generating location profiles that include searchable tags by verifying input data received from users.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A location profile generator computing device comprising a processor in communication with a memory and a user interface, said processor programmed to:
receive input data from a first user, the input data from the first user including a location identifier and at least a first searchable tag;
receive input data from a second user, the input data from the second user including the location identifier and including at least a second searchable tag;
verify the input data from the first and second users;
store the verified input data in the memory, the verified input data including the location identifier and the at least first and second searchable tags; and
generate a profile corresponding to the location identifier, the profile being associated with the at least first and second searchable tags.

2. The computing device of claim 1, wherein said processor is further programmed to verify the input data from the user by determining that the location identifier corresponds to transaction data associated with the user.

3. The computing device of claim 2, wherein the computing device further comprises a location profile application including computer-implementable instructions that are processed by said processor and wherein the transaction data associated with the user includes at least one of:
data associated with a check-in of the user into the location profile application via the user interface for confirming that the user has arrived at the location,
an order placement associated with the user through the application via the user interface that confirms that the user has placed an order for an item with a merchant at the location, or
a payment associated with the user through the application via the user interface that confirms that the user has paid a merchant at the location.

4. The computing device of claim 1, wherein said processor is further programmed to verify the input data from the user by determining that the location identifier corresponds to a geo-location of a user device from which the input data was received.

5. The computing device of claim 1, wherein said processor is further programmed to verify the input data by determining that the location identifier corresponds to location metadata associated with an image included in the input data.

6. The computing device of claim 1, wherein the searchable tag is a hashtag.

7. The computing device of claim 1, wherein the profile corresponding to the location identifier is a merchant profile.

8. The computing device of claim 1, wherein the input data from the second user is representative of input data from a plurality of users.

9. The computing device of claim 1, wherein said processor is further programmed to:
receive a search request including the previously stored first and second searchable tags;
determine that the previously stored first and second searchable tags included in the request are associated with at least one profile by performing a look-up within the memory using the previously stored first and second searchable tags; and
cause the one or more profiles associated with the first and second searchable tags to be displayed.

10. A method for generating location profiles based on verified user input, said method performed using a location profile generator computing device that includes a processor in communication with a memory and a user interface, said method comprising:
receiving input data from a first user, the input data from the first user including a location identifier and at least a first searchable tag;
receiving input data from a second user, the input data from the second user including the location identifier and including at least a second searchable tag;
verifying the input data from the first and second users;
storing the verified input data in the memory, the verified input data including the location identifier and the at least first and second searchable tags; and
generating a profile corresponding to the location identifier, the profile being associated with the at least first and second searchable tags.

11. The method of claim 10, wherein verifying the input data further comprises:
verifying the input data by retrieving transaction data associated with the first and second users; and
matching a location identifier from the transaction data to the location identifier inputted by the first and second user.

12. The method of claim 10, wherein verifying the input data further comprises verifying the input data by performing one of the following steps:
using data associated with a check-in of the user into a location profile application to confirm that the user has arrived at the location,
using an order placement associated with the user through the application to confirm that the user has placed an order for an item with a merchant at the location, or
using a payment associated with the user through the application to confirm that the user has paid a merchant at the location.

13. The method of claim 10, further comprising verifying the input data from the user by determining that the location identifier corresponds to a geo-location of a user device from which the input data was received.

14. The method of claim 10, further comprising verifying the input data by determining that the location identifier corresponds to location metadata associated with an image included in the input data.

15. The method of claim 10, wherein the searchable tag is a hashtag.

16. The method of claim 10, wherein the profile corresponding to the location identifier is a merchant profile.

17. The method of claim 10, wherein the input data from the second user is representative of input data from a plurality of users.

18. The method of claim 10, further comprising:
receiving a search request including the previously stored first and second searchable tags;
determining that the previously stored first and second searchable tags included in the request are associated with at least one profile by performing a look-up within the memory using the previously stored first and second searchable tags; and
causing the one or more profiles associated with the first and second searchable tags to be displayed.

19. A non-transitory computer-readable storage medium having computer-executable instructions embodied thereon, wherein when executed by a location profile generator (LPG) computing device that includes at least one processor coupled to a memory and a user interface, the computer-executable instructions cause the LPG computing device to:
receive input data from a first user, the input data from the first user including a location identifier and at least a first searchable tag;
receive input data from a second user, the input data from the second user including the location identifier and including at least a second searchable tag;
verify the input data from the first and second users;
store the verified input data in the memory, the verified input data including the location identifier and the at least first and second searchable tags; and
generate a profile corresponding to the location identifier, the profile being associated with the at least first and second searchable tags.

20. The non-transitory computer-readable storage media of claim 18, wherein the computer-executable instructions further cause the LPG computing device to verify the input data from the user by at least one of:
retrieving transaction data associated with the first and second users, and matching a location identifier from the transaction data to the location identifier inputted by the first and second user;
retrieving geo-location data associated with the first and second users from which the input data was received, and matching a location identifier from the geo-location data to the location identifier inputted by the first and second user; or
determining that the location identifier corresponds to location metadata associated with an image included in the input data.

21. The non-transitory computer-readable storage media of claim 18, wherein the computer-executable instructions further cause the LPG computing device to verify the input data from the user by performing at least one of the following steps:
using data associated with a check-in of the user into a location profile application to confirm that the user has arrived at the location,
using an order placement associated with the user through the application to confirm that the user has placed an order for an item with a merchant at the location, or
using a payment associated with the user through the application to confirm that the user has paid a merchant at the location.

22. The non-transitory computer-readable storage media of claim 18, wherein the searchable tag is a hashtag.

23. The non-transitory computer-readable storage media of claim 18, wherein the profile corresponding to the location identifier is a merchant profile.

24. The non-transitory computer-readable storage media of claim 18, wherein the input data from the second user is representative of input data from a plurality of users.

25. The non-transitory computer-readable storage media of claim 18, wherein the computer-executable instructions further cause the LPG computing device to:
receive a search request including the previously stored first and second searchable tags,
determine that the previously stored first and second searchable tags included in the request are associated with at least one profile by performing a look-up within the memory using previously stored first and second searchable tags, and
cause the one or more profiles associated with the first and second searchable tags to be displayed.
